(19) United States
(12) Patent Application Publication
(10) Pub. No.: US 2020/0020180 A1
(43) Pub. Date: Jan. 16, 2020

(54) DRIVING DATA RECORDING DEVICE FOR VEHICLE

(71) Applicant: Starry Concept Co., Ltd., New Taipei City (TW)

(72) Inventor: Cheng-Hsin YAO, New Taipei City (TW)

(21) Appl. No.: 16/451,479

(22) Filed: Jun. 25, 2019

(30) Foreign Application Priority Data
Jul. 11, 2018 (TW) 107123940

(51) Int. Cl. G07C 5/08; G07C 5/00

(52) U.S. Cl. CPC G07C 5/085; G07C 5/0825; G07C 5/008

(57) ABSTRACT

A driving data recording device for vehicles includes a plurality of sensing units, a processing unit, a display unit and a wireless transceiving unit. The sensing units are configured to detect a plurality of driving parameters. The processing unit is electrically connected to the sensing units, and the driving parameters are transmitted to the processing unit and converted to driving data through the processing unit. The display unit is electrically connected to the processing unit. A display interface is generated on the display unit. The driving data are displayed through the display interface. The wireless transceiving unit is electrically connected to the processing unit and connected to a serving unit through a network. The driving data are immediately transmitted to the serving unit through the wireless transceiving unit.

### BACKGROUND OF THE INVENTION

### Field of the Invention

The invention relates to a data recording device, and more particularly to a driving data recording device for a vehicle.

### Description of the Related Art

During the driving process, many knights or drivers would like to know more about the various states of the vehicles they use. The most common one is to record the state of the road conditions, such as a driving image recorder which is popular in the market. However the main function of the driving image record is to record images, and no more driving data can be provided. For example, it is impossible to know the various driving parameters of the vehicle itself.

In addition, as personal handheld devices (smart phones and tablets) have the improved performance, and handheld devices have become so popular in everyone's lives. The applicable programs of the handheld devices include every field of our daily life.

Handheld devices have also led a revolution in the electronics and information industries, which has led to an infinite number of opportunities in the new field of innovation, the internet of things (IoT). As the technical field of the IoT also becomes popularized due to the development of the handheld devices, the products in the basis of IoT are thus produced.

### BRIEF SUMMARY OF THE INVENTION

An object of the invention also provides a driving data recording device for vehicles capable of recording driving data of a vehicle (automobiles or motor cycles). The driving data can be uploaded to a video platform immediately via a communication network of a handheld device. A user must not transmit the driving data to a computer or related editing devices, and then the driving data is further transmitted to the audio-video platform.

The invention provides a driving data recording device. The driving data recording device in accordance with an exemplary embodiment of the invention includes a plurality of sensors configured to detect a plurality of driving parameters of the vehicle; a processing unit connected to the sensors, wherein the driving parameters are transmitted to the processing unit and calculated by the processing unit to obtain a plurality of driving data; a display unit connected to the processing unit and configured to generate a display interface on which the driving data are displayed; and a wireless transceiving unit connected to the processing unit and connected to a serving unit through a network, wherein the driving data are transmitted to the serving unit through the wireless transceiving unit immediately.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1-1 is a block diagram of an embodiment of a driving data recording device for a vehicle of the present invention;

FIG. 1-2 is a block diagram of another embodiment of a driving data recording device for a vehicle of the present invention;

FIG. 1-3 is a block diagram of another embodiment of a driving data recording device for a vehicle of the present invention;

FIG. 1-4 is a block diagram of another embodiment of a driving data recording device for a vehicle of the present invention;

FIG. 2 is an embodiment of a display interface of a driving data recording device for a vehicle of the present invention; and

FIG. 3 is another embodiment of a display interface of a driving data recording device for a vehicle of the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

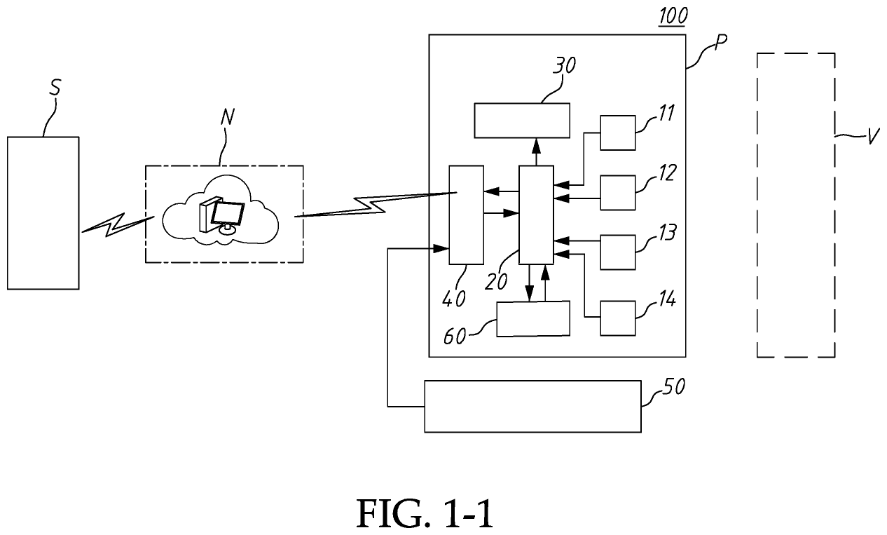

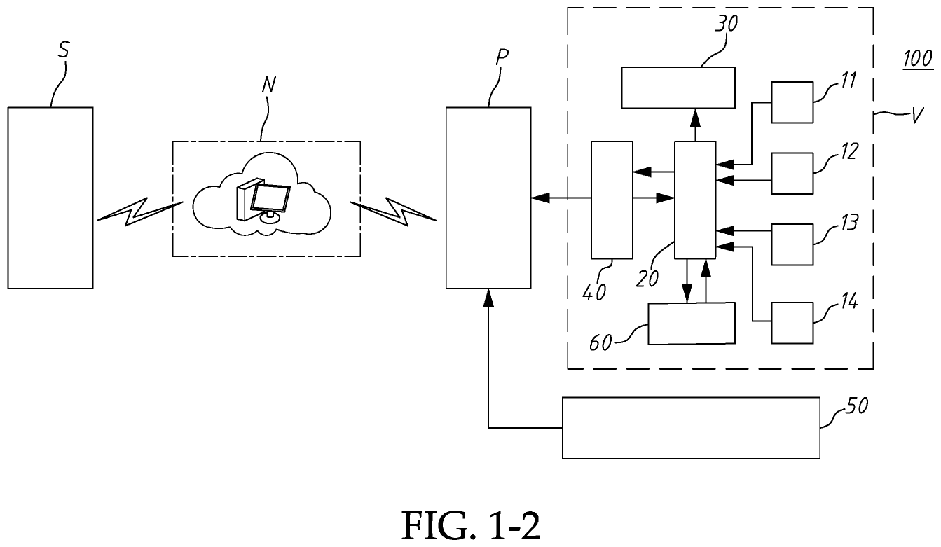

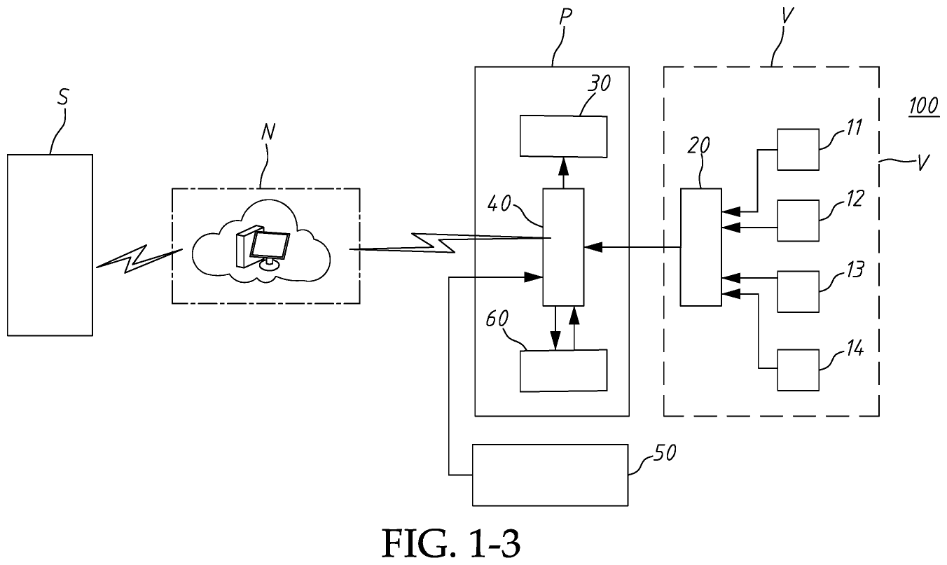

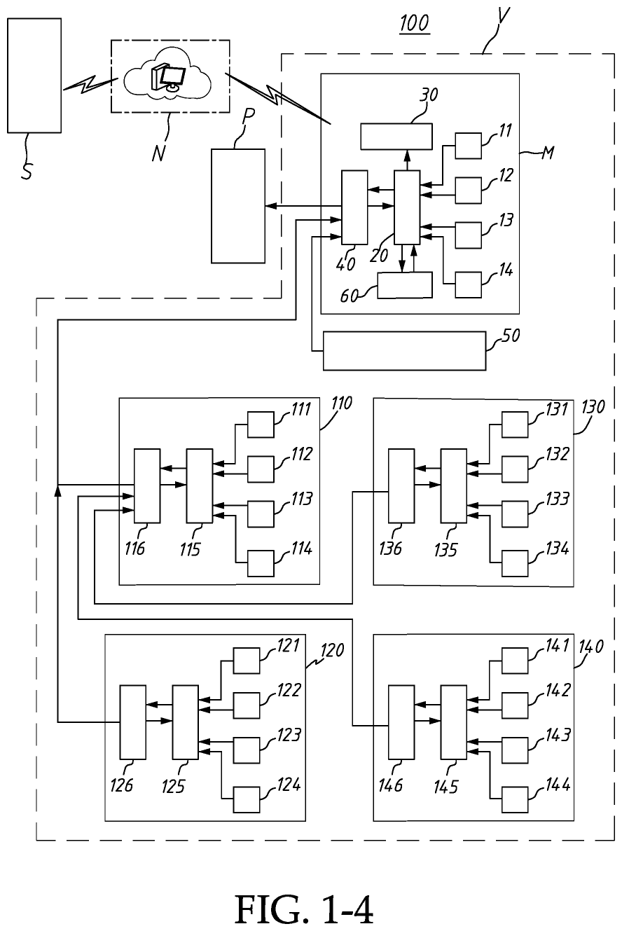

Referring to FIGS. 1-1, 1-2 and 1-3, several embodiments of a driving data recording device for a vehicle of the present invention are disclosed. The driving data recording device 100 for a vehicle of the present invention is used for recording driving data of a vehicle. The driving data recording device 100 includes a plurality of sensing units 11, 12, 13, 14, a processing unit 20, a display unit 30, and a wireless transceiving unit 40. The sensing units 11, 12, 13, 14 are configured to detect a plurality of driving parameters of the vehicle. For example, the sensing unit 11 can receive the GPS signal, and the sensing unit 12 can be a gyroscope detecting the angle change of the vehicle. The sensing unit 13 can be a gravity sensor (G-sensor) detecting the inclination condition of the vehicle relative to a running surface. The sensing unit 14 can be an acceleration sensor. The processing unit 20 is connected to the sensing units 11, 12, 13, 14, and the driving parameters detected by the sensing units 11, 12, 13, 14 are transmitted to the processing unit 20. The processing unit 20 performs calculations to obtain a plurality of driving data of the vehicle, such as the position coordinates of the vehicle and the traveling speed of the vehicle. The display unit 30 is connected to the processing unit 20 and generates a display interface. The driving data are displayed on the display unit 30. The display unit 30 is connected to the processing unit 20, and the display unit 30 is connected to the processing unit 20 and generates a display interface. The wireless transceiver unit 40 is connected to the processing unit 20 and connected to a serving unit S via a network N. The driving data can be immediately transmitted to the serving unit S via the wireless transceiving unit 40.

In the present embodiment, the vehicle may be a motor cycle, but the invention is not limited thereto, and in another embodiment, the vehicle may also be an automobile, a ship or an aircraft.

As shown in FIG. 1-1, the driving data recording device 100 of the present invention includes a handheld device P. That is, the handheld device P has the aforementioned sensing units 11, 12, 13, 14, the processing unit 20, the display unit 30 and the wireless transceiver unit 40. The handheld device P can be a smart mobile phone, and the smart mobile phone has a sensing unit such as a GPS receiving chip, a gyroscope, a gravity sensor, an acceleration sensor, etc., and a motor cycle driver or an automobile driver usually mounts a bracket on the vehicle body for holding a mobile device (smart mobile phone). The user can install the smart mobile phone on the bracket, so that the sensing unit in the smart mobile phone can be used to detect the driving state (driving parameters) of the vehicle itself. The phone itself also has a processor, a display panel, etc., and an appropriate application program can be installed in the smart mobile phone. The application program can generate a display interface and can apply the driving data detected by each of the sensing units. Driving data are integrated into the display interface. Combined with the concept of the Internet of Things, smart mobile phones can use their own communication networks, such as the third-generation communication networks and fourth-generation communication networks currently in use, and even the fifth in the future. On behalf of the communication network, the detected driving data are instantly transmitted to a cloud or a distant serving unit S. The driving data are played on a video website, and do not need to be stored forehand, and then processed by the computer or the related editing device and finally uploaded to the cloud.

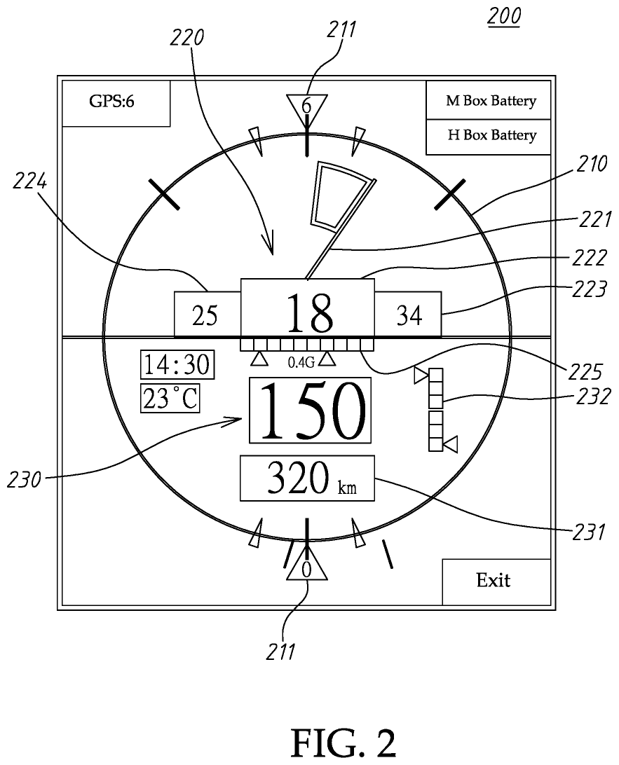

As shown in FIG. 1-2, in another embodiment, the driving data recording device 100 of the present invention may also be mounted in the vehicle V, and the vehicle V has the sensing units 11, 12, 13 and 14, the processing unit 20, the display unit 30 and the wireless transceiving unit 40. For example, the vehicle having the automatic driving function itself has a sensing unit such as a GPS receiving chip, a gyroscope, a gravity sensor, an acceleration sensor, and the like. The driving computer receives the driving data detected by the sensing units. The audio and video system of the vehicle has the display unit 30, which can display the driving data in the display unit 30 of the audio-video system, and the driving data can be transmitted to the handheld device P of the driver through the wireless transceiving unit 40, such as a smart mobile phone. The driving data can be transmitted to a cloud or remote serving unit S by using the communication network of the smart mobile phone, and the driving data can be displayed in a video website does not need to be stored in advance. After the driving data are processed by the computer or related editing devices, the driving data are uploaded to the cloud.

As shown in FIG. 1-3, in another embodiment, the driving data recording device 100 of the present invention may also be a device partially mounted in the vehicle V. For example, the vehicle V has the aforementioned sensing units 11. 12, 13 and 14, the processing unit 20. The display unit 30 and the wireless transceiver unit 40 are the display panel and the wireless communication modules of the handheld device P. When the sensing units 11, 12, 13, 14 of the vehicle detect physical parameters (driving parameters), the physical parameters are transmitted to the processing unit 20. The processing unit 20 calculates the physical parameters to obtain the driving data of the vehicle V, such as the position coordinates of the vehicle V, the traveling speed of the vehicle, the steering angle of the vehicle V, the inclination angle of the vehicle V with respect to the running surface and the acceleration of the carrier V, etc., and the driving data are transmitted to the handheld device P, on which the application program is installed. The application program can generate a display interface, and the driving data detected by each of the sensing units 11, 12, 13, and 14 can be integrated to the display interface. The driving data can be transmitted to the cloud or the remote server unit S by the wireless communication module of the handheld device P via the wireless communication network N, and the driving data are played from a video website without being stored in advance. Afterwards, the detected driving data, are processed by the computer or related editing device and uploaded to the cloud.

Referring to FIGS. 1-4, another embodiment of the driving data recording device of the present invention. The driving data recording device 100 of the present invention includes a main apparatus M, two auxiliary devices 110 and 120, and two expansion apparatuses 130 and 140. In this embodiment, the main device M, the auxiliary devices 110 and 120, and the expansion devices 130 and 140 may be mounted in the vehicle V, wherein the auxiliary devices 110 and 120 are connected to the main device M, and the expansion devices 130 and 140 are connected to the auxiliary device 110. The main device M includes a plurality of sensing units 11, 12, 13, 14, a processing unit 20, a display unit 30, and a wireless transceiving unit 40. The main device M is connected to a handheld device P, and the handheld device P is connected to a serving unit S via the network. N, and the main device M itself can be directly connected to the serving unit S via the network N. The auxiliary device 110 includes a plurality of auxiliary sensing units 111, 112, 113, 114, a auxiliary processing unit 115, and a auxiliary wireless transceiving unit 116. The driving parameter detected by detected by the auxiliary sensing units 111, 112, 113, and 114 are transmitted to the auxiliary processing unit 115, and further transmitted to the main device M via the auxiliary wireless transceiving unit 116. Similarly, the auxiliary device 120 includes a plurality of auxiliary sensing units 121, 122, 123 and 124, the auxiliary processing unit 125, and the auxiliary wireless transceiving unit 126. The driving parameters detected by the auxiliary sensing units 121, 122, 123, and 124 are transmitted to the auxiliary processing unit 125, and further transmitted to the main device M via the auxiliary wireless transceiving unit 126. The expansion device 130 includes a plurality of expansion sensing units 131, 132, 133, 134, an expansion processing unit 135, and an expansion wireless transceiving unit 136. The driving parameters detected by the expansion sensing units 131, 132, 133, 134 are transmitted to the expansion processing unit 135, and further transmitted to the auxiliary device 110 via the expansion wireless transceiving unit 136. The expansion device 140 includes a plurality of expansion sensing units 141, 142, 143, 144, an expansion processing unit 145, and an expansion wireless transceiving unit 146. After the driving parameters are detected by the expansion sensing units 141, 142, 143, and 144, the driving parameters are transmitted to the expansion processing unit 145, and further transmitted to the auxiliary device 110 via the expansion wireless transceiving unit 146. In the present embodiment, for example, the main device M is a host of a vehicle, the auxiliary device 110 may be, for example, an auxiliary device that integrates all the operating parameters of the vehicle chassis, and the expansion devices 130 and 140 may respectively be different expansion devices for detecting tires (for example, tire pressure) and driving parameters of the shock absorbers. The driving parameters detected by the expansion detecting units of the expansion devices 130 and 140 are calculated by the expansion processing units 135 and 145 to obtain a plurality of driving data. The driving data are sent to the auxiliary processing unit 115 of the auxiliary device 110 for calculation, and then integrated driving data are transmitted to the processing unit 20 of the main device M.

It is described herein that each of the wireless transceiving units illustrated in FIGS. 1-1 to 1-4 includes a wireless transceiving using various communication protocols, such as wireless Internet access (WiFi), Bluetooth, and Bluetooth Low Energy (BLE) or a mobile communication network 3G, 4G or even 5G.

In the present embodiment, the driving data recording device 100 further includes an image recording device 50 for recording road condition images in the travel path, and the road condition image captured by the image recording device 50 can be transmitted to the serving unit S by the wireless transceiving unit 40 via the network N. The image recording device 50 can be connected to the handheld device P in a wired or wireless manner, or the image recording device 50 can be directly connected to the serving unit S via the network N. In an embodiment, the image recording device 50 can be a driving recorder. In another embodiment, the image recording device 50 can also be a lens. The road condition image captured by the image recording device 50 is transmitted to the handheld device, and can be displayed in the display unit 30 of the handheld device along with the driving data synchronously.

In the present embodiment, the driving data recording device 100 further includes a storage unit 60, and the detected driving data or road condition images may also be stored in the storage unit 60 synchronously. For example, in a mountainous area, in a poor weather condition or other environmental or human factors, when the driving data recording device 100 cannot be connected to the serving unit S via the network N, the driving data of the vehicle V may be stored in the storage unit 60, and transmitted to the servo unit S via the network N when the connection of the network N is restored.

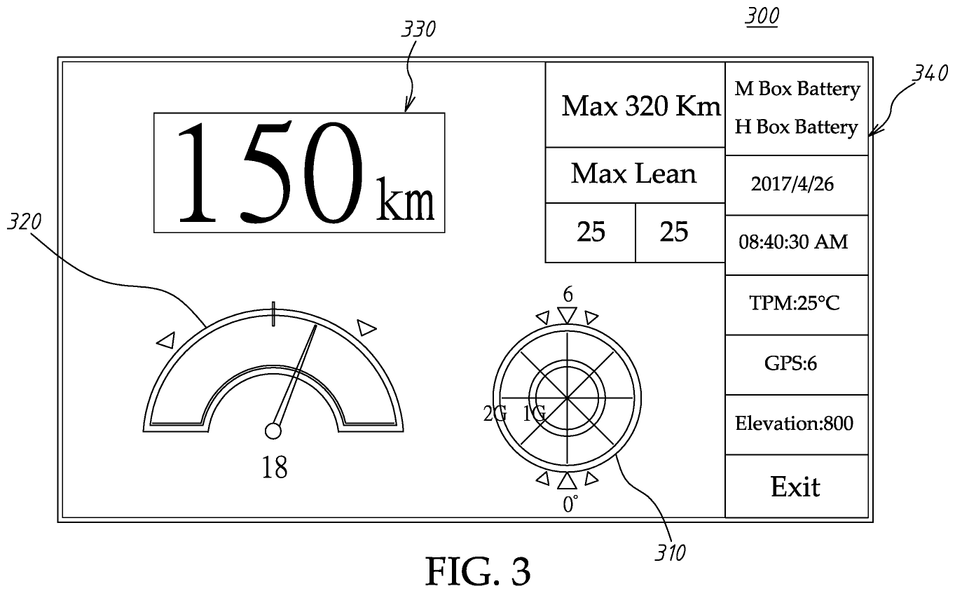

Referring to FIGS. 2 and 3, the display interface 200 of the vehicle travel information recording device of the present invention is shown. As shown in FIG. 2, the center of the display interface 200 has a circular vehicle steering angle display area 210. Each of the vehicle steering angle display area 210 has two inverted triangles 211 formed thereabove and therebelow. The steering angles of the vehicle head and vehicle tail are displayed in the inverted triangles 211. The inverted triangles 211 moves on the outer circumference of the vehicle steering angle display area 210 along with the steering angle of the vehicle head and tail. An inclination angle display area 220 is formed inside the vehicle steering angle display area 210. The inclination angle display area 220 has a pointer 221 capable of swinging left and right. The pointer 221 is in a state of swinging to the left or to the right as the left or right tilt of the vehicle, and the inclination angle display area 220 has three display blocks 222, 223, and 224. The middle display block 222 displays the current tilt value of the vehicle, the right display block 223 displays the maximum value of the right tilt angle, and the left display block 224 displays the maximum value of the left tilt angle. A left/right tilt G force display areas 225 is formed below the display block 222. A speed display area 230 is also formed in the circular vehicle steering angle display area 210. The speed display area 230 displays the current vehicle speed, for example, a speed of 150 Km/h. Speed display region 230 includes a block 231, which shows the highest speed of the vehicle. A vehicle acceleration and braking force display area 232 is formed on the right side of the speed display area 230. In addition, in the embodiment, the display interface 200 also displays some general information such as time, temperature, battery power, and the number of satellites of the GPS.

As shown in FIG. 3, it shows a display interface 300 of the driving data recording device of the present invention. The display interface 300 includes a vehicle steering angle display area 310, an inclination angle display area 320, a speed display area 330, and a general information display area 340. In the present embodiment, the vehicle steering angle display area 310, the inclination angle display area 320, the speed display area 330, and the general information display area 340 are disposed separately from each other.

The vehicle travel information recording device 100 of the present invention can completely record the driving data of the vehicle while traveling, and the driving data are displayed to the user immediately or transmitted to the cloud or the remote server via the network. Afterwards, the driving data can be played on an audio and video platform.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A driving data recording device for a vehicle, comprising:
A plurality of sensors configured to detect a plurality of driving parameters of the vehicle;
a processing unit connected to the sensors, wherein the driving parameters are transmitted to the processing unit and calculated by the processing unit to obtain a plurality of driving data;
a display unit connected to the processing unit and configured to generate a display interface on which the driving data are displayed; and
a wireless transceiving unit connected to the processing unit and connected to a serving unit through a network, wherein the driving data are transmitted to the serving unit through the wireless transceiving unit immediately.

2. The driving data recording device as claimed in claim 1, further comprising a handheld device detachably mounted in the vehicle, wherein the sensors, the processing unit, the display unit and the wireless transceiving unit are disposed in the handheld device.

3. The driving data recording device as claimed in claim 2, wherein the display interface are generated by a applicable program installed in the handheld device.

4. The driving data recording device as claimed in claim 1, wherein the sensors, the processing unit, the display unit and the wireless transceiving unit are disposed in the vehicle.

5. The driving data recording device as claimed in claim 4, further comprising an auxiliary device, wherein the auxiliary device comprises an auxiliary sensors, an auxiliary processing unit and an auxiliary wireless transceiving unit, the driving parameters detected by the auxiliary sensors are transmitted to the auxiliary processing unit and calculated by the auxiliary processing unit, and the calculated driving parameter are transmitted to the processing unit.

6. The driving data recording device as claimed in claim 5, further comprising an expansion device, wherein the expansion device comprises a plurality of expansion sensors, an expansion processing unit and an expansion wireless transceiving unit, the driving parameters detected by the expansion sensors are transmitted to the expansion processing unit and calculated by the expansion processing unit, and the calculated driving parameter are transmitted to the auxiliary processing unit, and further transmitted to the processing unit through the auxiliary processing unit.

7. The driving data recording device as claimed in claim 4, wherein the display device is disposed on the vehicle, the wireless transceiving unit is connected to a handheld device, the driving data are transmitted to the serving unit through a communication network of the handheld device.

8. The driving data recording device as claimed in claim 1, wherein the sensors and the processing unit are disposed in the vehicle, the display unit and the wireless transceiving unit is disposed in a handheld device, and the driving data are transmitted to the handheld device and transmitted to the serving unit through the wireless transceiving unit.

9. The driving data recording device as claimed in claim 8, wherein the display interface comprises a speed display region, a vehicle inclination angle display region and a vehicle steering angle display region.

10. The driving data recording device as claimed in claim 4, wherein the display interface comprises a speed display region, a vehicle inclination angle display region and a vehicle steering angle display region.

11. The driving data recording device as claimed in claim 2, wherein the display interface comprises a speed display region, a vehicle inclination angle display region and a vehicle steering angle display region.

12. The driving data recording device as claimed in claim 1, wherein the display interface comprises a speed display region, a vehicle inclination angle display region and a vehicle steering angle display region.

13. The driving data recording device as claimed in claim 12, wherein the speed display region, the vehicle inclination angle display region and the vehicle steering angle display region are separated from each other.

14. The driving data recording device as claimed in claim 13, wherein the display interface further comprises a general information display region separated from the speed display region, the vehicle inclination angle display region and the vehicle steering angle display region.

15. The driving data recording device as claimed in claim 12, wherein the speed display region and the vehicle inclination angle display region are disposed in the vehicle steering angle display region.

16. The driving data recording device as claimed in claim 2, further comprising a video recording device configured to record road condition images, wherein the video recording device is connected to the serving unit through the network, and the road condition images are transmitted to the handheld device and further transmitted to the serving unit from the handheld device via the network.

17. The driving data recording device as claimed in claim 16, wherein the road condition images along with the driving data are displayed on the display unit synchronously.

18. The driving data recording device as claimed in claim 1, further comprising a video recording device configured to record road condition images, wherein the video recording device is connected to the serving unit through the network, and the road condition images are transmitted to the serving unit via the network.

19. The driving data recording device as claimed in claim 1, further comprising a storage unit, wherein the driving data are stored in the storage unit.
